(19) United States
(12) Patent Application Publication
(10) Pub. No.: US 2022/0353960 A1
(43) Pub. Date: Nov. 3, 2022

(54) MICROWAVE TREATMENT DEVICE

(71) Applicant: Panasonic Intellectual Property Management Co., Ltd., Osaka (JP)

(72) Inventors: DAISUKE HOSOKAWA, Shiga (JP); KAZUKI MAEDA, Shiga (JP); YOSHIHARU OOMORI, Shiga (JP); KOJI YOSHINO, Shiga (JP); TAKASHI UNO, Shiga (JP); FUMITAKA OGASAWARA, Hyogo (JP)

(21) Appl. No.: 17/621,070

(22) PCT Filed: Jul. 28, 2020
(86) PCT No.: PCT/JP2020/028816

§ 371 Date: Dec. 20, 2021

(30) Foreign Application Priority Data
Jul. 31, 2019 (JP) 2019-140413

(51) Int. Cl. H05B 6/64; H05B 6/68; H05B 6/70

(52) U.S. Cl. CPC H05B 6/6447; H05B 6/687; H05B 6/705

(57) ABSTRACT

A microwave treatment device comprises: a heating chamber that accommodates a heating target, a microwave generator that generates a microwave; a feeding unit that supplies the microwave to the heating chamber; a reflected microwave power detector that detects a reflected microwave power returned to the microwave generator; a controller that controls the microwave generator; and a storage unit. The storage unit stores a level of the reflected microwave power detected by the reflected microwave power detector together with a frequency of the microwave supplied to the heating chamber and an elapsed time after a start of heating the heating target. The controller causes the microwave generator to execute a frequency sweep over a specified frequency band and determines that the heating target is in a boiling state based on a temporal change in a value that is obtained based on the reflected microwave power at each frequency.

### TECHNICAL FIELD

The present disclosure relates to a microwave treatment device having a microwave generator.

### BACKGROUND ART

Such a conventional microwave treatment device is known that detects a boiling state of a heating target based on a temporal change in the amount of the reflected microwave and changes the oscillation frequency and the oscillation amplitude level of a semiconductor oscillator (see PTL 1, for example).

The boiling state is detected based a change in the amount of the reflected microwave or a change in the proportion of the amount of the reflected microwave to the amount of the incident microwave. As an index representing the magnitude of the change, a difference from an average value and a standard deviation is used in addition to an absolute value. The microwave heating is finished or suppressed at the time the boiling state has been detected to sophisticatedly control the temperature of the food.

### CITATION LIST

### Patent Literature

PTL 1: International Publication No. 2018/125147

### SUMMARY OF THE INVENTION

However, the device disclosed in PTL 1 has a room for improvement in the point of accurately detecting the boiling state of the heating target. Therefore, an object of the present disclosure is to accurately detect the boiling state of the heating target in a microwave treatment device.

A microwave treatment device in an aspect of the present disclosure comprises: a heating chamber that accommodates a heating target; a microwave generator that generates a microwave; a feeder that supplies the microwave to the heating chamber; a reflected-microwave-power detector that detects a reflected microwave power returned to the microwave generator; a controller that controls the microwave generator; and a storage. The storage stores a level of the reflected microwave power detected by the reflected-microwave-power detector together with a frequency of the microwave supplied to the heating chamber and an elapsed time after a start of heating the heating target.

The controller causes the microwave generator to execute a frequency sweep over a specified frequency band. The controller determines that the heating target is in a boiling state based on a temporal change in a value that is obtained based on the reflected microwave power at each frequency.

According to the microwave treatment device in this aspect, it is possible to accurately detect the boiling state of the heating target.

### BRIEF DESCRIPTION OF DRAWINGS

FIG. 1 is a schematic configuration diagram of a microwave treatment device according to an exemplary embodiment of the present disclosure.

FIG. 2 is a flowchart showing a cooking control flow in the present exemplary embodiment.

FIG. 3 is a flowchart showing details of a process of detecting the reflected microwave power in the present exemplary embodiment.

FIG. 4 is a conceptual diagram showing detection of boiling of a heating target based on a change in the reflected microwave power.

FIG. 5A is a diagram showing temporal changes in the temperature of the heating target and in the frequency average of the standard deviation regarding the proportion of the reflected microwave to the incident microwave in a case where the weight of the heating target is 1200 g.

FIG. 5B is a diagram showing temporal changes in the temperature of the heating target and in the frequency average of the standard deviation regarding the proportion of the reflected microwave to the incident microwave in a case where the weight of the heating target is 400 g.

FIG. 5C is a diagram showing temporal changes in the temperature of the heating target and in the frequency average of the standard deviation regarding the proportion of the reflected microwave to the incident microwave in a case where the weight of the heating target is 200 g.

FIG. 6 is a contour diagram showing temporal changes in the standard deviation at intervals of 10 seconds at each frequency.

### DESCRIPTION OF EMBODIMENTS

Knowledges on which the Present Disclosure is Based:

The microwave treatment device disclosed in PTL 1 detects the boiling state based on a change in the level of the reflected microwave power, which is a reflected part of the microwave supplied to the heating chamber, and a change in the proportion of the reflected microwave power to the incident microwave power. More specifically, the index used for the boiling detection is the absolute value of the change in the above-mentioned value, a difference of the change from an average value per an arbitrary length of time, or a standard deviation of the change.

However, it is difficult to accurately detect the boiling state without considering the frequency characteristics of the microwave. As a reason for the difficulty, the degree of the change in the reflected microwave power in response to the change in the state of the heating target such, for example, as boiling varies depending on the frequency. In other words, there is a frequency at which the change in the reflected microwave power in response to the boiling of liquid is large, and a frequency at which the change in the reflected microwave power in response to the boiling of liquid is small. These frequencies depend largely on the standing wave distribution of the microwave within the heating chamber. Therefore, the kind, viscosity, volume, shape, location of the heating target, and the shape of the heating chamber influence largely on the reflected microwave power.

Accordingly, it is difficult in the actual circumstances of cooking a variety of heating targets to detect the boiling state using a single frequency or frequencies in a narrow frequency band.

The inventors have diligently studied and reached the below-described invention by which the boiling state of the heating target can be accurately detected based on a change in the reflected microwave power considering the frequency characteristic.

A microwave treatment device in a first aspect of the present disclosure comprises: a heating chamber that accommodates a heating target; a microwave generator that generates a microwave; a feeder that supplies the microwave to the heating chamber; a reflected-microwave-power detector that detects a reflected microwave power returned to the microwave generator; a controller that controls the microwave generator; and a storage. The storage stores a level of the reflected microwave power detected by the reflected-microwave-power detector together with a frequency of the microwave supplied to the heating chamber and an elapsed time after a start of heating the heating target.

The controller causes the microwave generator to execute a frequency sweep over a specified frequency band. The controller determines that the heating target is in a boiling state based on a temporal change in a value that is obtained based on the reflected microwave power at each frequency.

A microwave treatment device in a second aspect of the present disclosure, which is based on the first aspect, further comprises an incident-microwave-power detector that detects an incident microwave power of the microwave generated by the microwave generator. A proportion of the reflected microwave power to the incident microwave power is used as the value that is obtained based on the reflected microwave power.

In a microwave treatment device in a third aspect of the present disclosure, which is based on the first or second aspect, the controller determines that the heating target is in the boiling state based on either a change in a variance of the value that is obtained based on the reflected microwave power in a predetermined time or a change in a frequency average of the variance.

In a microwave treatment device in a fourth aspect of the present disclosure, which is based on the first or second aspect, the controller determines that the heating target is in the boiling state based on either a change in a standard deviation of the value that is obtained based on the reflected microwave power in a predetermined time or a change in a frequency average of the standard deviation.

In a microwave treatment device in a fifth aspect of the present disclosure, which is based on the third or fourth aspect, the predetermined time is equal to or longer than twice a period of the frequency sweep.

In a microwave treatment device in a sixth aspect of the present disclosure, which is based on any one of the first to fourth aspects, the controller determines that the heating target is in the boiling state in a case where a change exceeds a threshold value at two or more frequencies.

In a microwave treatment device in a seventh aspect of the present disclosure, which is based on any of the first to sixth aspects, a bandwidth of the frequency sweep is equal to or wider than 30 MHz.

In a microwave treatment device in an eighth aspect of the present disclosure, which is based on any one of the first to seventh aspects, a frequency interval of the frequency sweep is equal to or narrower than 10 MHz.

In a microwave treatment device in a ninth aspect of the present disclosure, which is based on any one of the first to eighth aspects, the controller determines that the heating target is in the boiling state in a case where the change in the value that is obtained based on the reflected microwave power exceeds a threshold value at least twice.

In a microwave treatment device in a tenth aspect of the present disclosure, which is based on any one of the first to ninth aspects, the controller causes the microwave wave generator to execute the frequency sweep after the heating target in a liquid state has been placed in the heating chamber and a time necessary for fluctuations of a surface of the heating target to stop has elapsed after a start of heating the heating target.

Hereinafter, a microwave treatment device according to an exemplary embodiment of the present disclosure will be described with reference to the drawings.

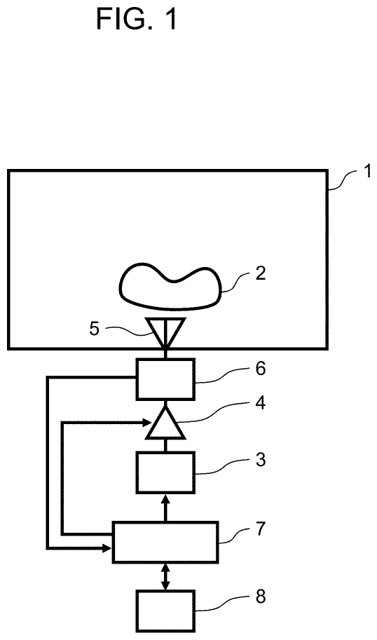

FIG. 1 is a schematic configuration diagram of a microwave treatment device according to the present exemplary embodiment. As shown in FIG. 1, a microwave treatment device in the present exemplary embodiment comprises heating chamber 1, microwave generator 3, amplifier 4, feeder 5, detector 6, controller 7, and storage 8.

Heating chamber 1 accommodates heating target 2, which is a load. Microwave generator 3 has a capability to generate a microwave with an arbitrary frequency in a specific frequency band and generates a microwave with a frequency selected by controller 7.

Amplifier 4 is configured, for example, by a semiconductor device. Amplifier 4 amplifies the microwave generated by microwave generator 3 according to an instruction by controller 7 to output a microwave having a desired output power.

Feeder 5 is configured by an antenna and supplies the microwave amplified by amplifier 4 as an incident microwave power to heating chamber 1. A part of the incident microwave power which has not been consumed by heating target 2 or the like becomes a reflected microwave power that is returned from heating chamber 1 through feeder 5 to amplifier 4.

Detector 6 is configured, for example, by a directional coupler. Detector 6 detects the incident microwave power and the reflected microwave power and informs controller 7 of the levels of the detected incident microwave power and the detected reflected microwave power. In other words, detector 6 functions as both an incident-microwave-power detector and a reflected-microwave-power detector. Storage 8 is configured, for example, by a memory device and stores data sent from controller 7. Also, storage 8 reads out the stored data and sends the read-out data to controller 7.

Controller 7 is configured by a microcomputer having an on-board central processing unit (CPU). Controller 7 controls microwave generator 3 and amplifier 4 based on information from detector 6 and storage 8 to execute a cooking control in the microwave treatment device.

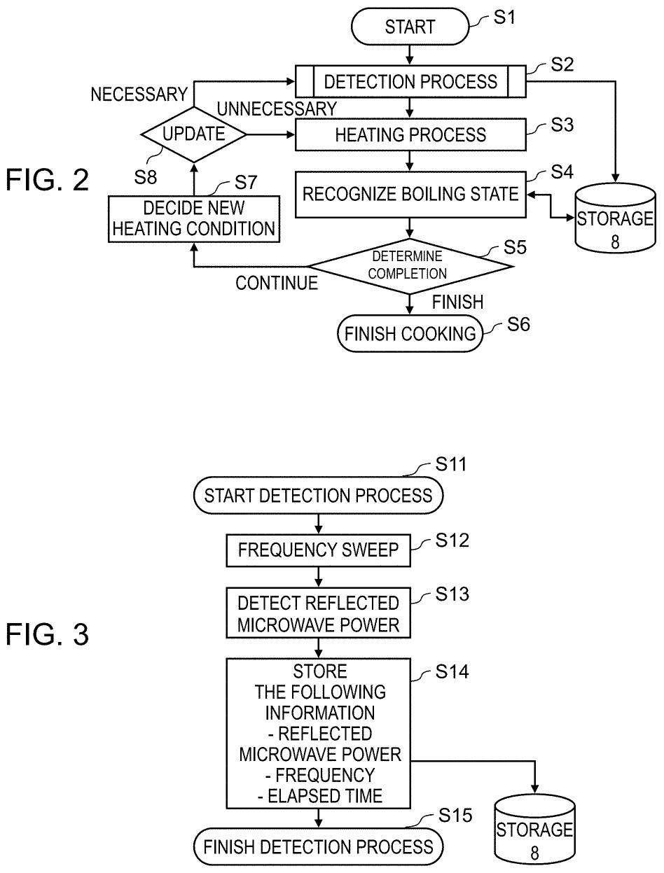

FIG. 2 is a flowchart showing a cooking control flow in the microwave treatment device according to the present exemplary embodiment. In response to a user's operation instructing the microwave treatment device to start cooking (step S1), controller 7 first executes a detection step (step S2).

FIG. 3 is a flowchart showing details of the detection step (step S2). When the detection step has been started (step S11), microwave generator 3 generates a microwave while sequentially changing the frequency of the microwave at predetermined frequency intervals over a specified frequency band (e.g., 2.40 GHz to 2.50 GHz) (step S12). Hereinafter, the operation of sequentially changing the frequency at predetermined frequency intervals over the specified frequency band will be referred to as a frequency sweep.

Microwave generator 3 generates the microwave while executing the frequency sweep, and detector 6 detects a reflected microwave power at each frequency. In this operation, a frequency characteristic of the reflected microwave power can be obtained (step S13).

After heating target 2 in a liquid state has been placed in heating chamber 1 and a time necessary for fluctuations of a surface of the heating target to stop (five to ten seconds) has elapsed after a start of heating target 2, controller causes microwave generator 3 to execute the frequency sweep in step 12 and causes detector 6 to detect the reflected microwave power in step S13.

Storage 8 stores the level of the reflected microwave power at each frequency obtained in step S13 together with the frequency of the microwave supplied to heating chamber 1 and an elapsed time after the start of heating (step S14). Controller 7 calculates a value that is to be used for detecting the boiling state based on an obtained frequency characteristic of the reflected microwave power and finishes the detection process (step S15).

The process flow returns to the flowchart shown in FIG. 2 to heat heating target 2 by microwave heating (step S3). In the heating process in step S3, the microwave heating may be used together with an oven heating or a radiation heating using a heater or a steam heating using a steam generator.

Based on a temporal change in the value that is obtained based on the reflected microwave power at each frequency obtained in step S2, controller 7 recognizes the boiling state of heating target 2 (step S4). In a completion determination (step S5), controller 7 determines whether or not heating target 2 is in the boiling state. In a case where controller 7 determines that heating target 2 is in the boiling state, controller 7 finishes the cooking process (step S6).

Otherwise, controller continues the cooking process and determines a new heating condition as necessary (step S7). Controller 7 determines whether or not it is necessary to update the value of the reflected microwave power at each frequency for the reason that a long time has passed after the start of cooking or for the reason that the heating condition has changed (step S8). If any update is necessary, the processing flow goes to the detection step (step S2). Otherwise, the processing flow goes to the heating process (step S3).

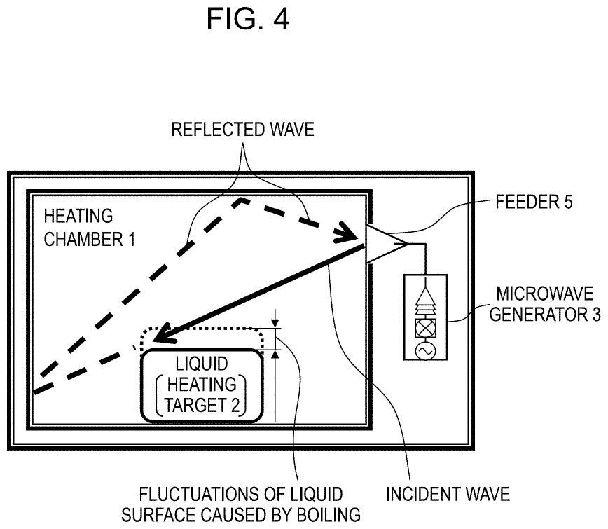

FIG. 4 is a conceptual diagram showing a process of recognizing a boiling state of heating target 2, which is a liquid object, based on a change in the reflected microwave power (step S4). As shown in FIG. 4, microwave generator 3 supplies the microwave as the incident microwave to heating chamber 1. A part of the incident microwave is absorbed by heating target 2 (liquid). The remaining part of the microwave is not absorbed by heating target 2 and returns as a reflected microwave to feeder 5.

The standing wave distribution in heating chamber 1 changes depending on the frequency of the supplied microwave. Therefore, such cases occur at a particular frequency, depending on the fluctuations of the liquid surface, that a large amount of microwave is absorbed by heating target 2 and that only a small amount of microwave is absorbed by heating target 2. Accordingly, controller 7 calculates, as the value that is obtained based on the reflected microwave power at each frequency, a variation of the reflected microwave power level such, for example, as a variance or a standard deviation in a predetermined time. Since the value of the variation of the reflected microwave power level such, for example, as the variance or the standard deviation increases when the liquid is boiling, the boiling state can be detected based on such value.

The predetermined time may preferably be equal to or longer than twice a period of the frequency sweep. It is preferable that controller 7 determines that heating target 2 is in the boiling state in a case where the change exceeds a threshold value at two or more frequencies.

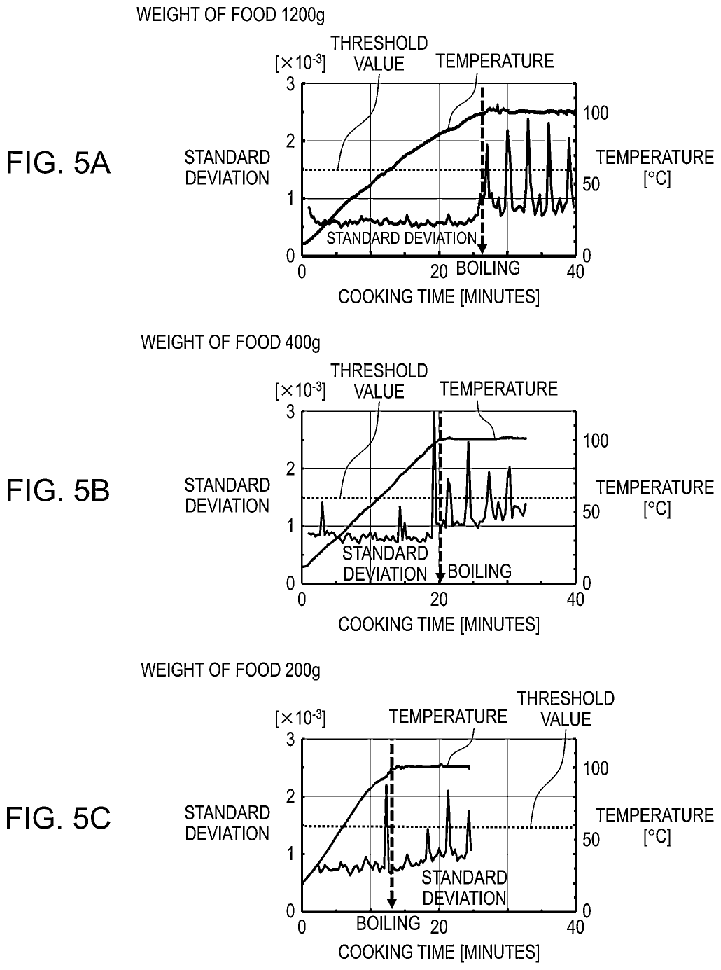

Each of FIGS. 5A to 5C is a graph showing a temporal change in the temperature of heating target 2 and a temporal change in the frequency average of the standard deviation in 10 seconds regarding the proportion of the reflected microwave power to the incident microwave power in a case of cooking pot-au-feu as heating target 2. In place of the standard deviation in a predetermined time, a change in a variance or a change in a frequency average of the variance may be referred.

In the experiment, a fiber-optical thermometer is inserted into heating target 2 to measure the temperature of heating target 2. Microwave generator 3 generates the microwave while changing the frequency in 1 MHz steps at intervals of 20 milliseconds from 2400 MHz to 2500 MHz. Controller 7 causes the microwave treatment device to operate in a 200 W microwave heating mode and a 2000 W oven heating mode each with a temperature setting at 250° C.

FIGS. 5A, 5B and 5C show experimental results in cases where the weight of heating target 2 is 1200 g, 400 g, and 200 g, respectively. The weight of water contained in heating target 2 and the weight of ingredients contained in heating target 2 are the same in each of the experiments. The ingredients include ginseng, potato, and wiener sausage, each having the same weight.

As shown in FIGS. 5A to 5C, the standard deviation increases largely when the temperature of heating target 2 becomes around 100° C. At this time, it can be visually confirmed that heating target 2 is boiling.

In the above experiment, granular consomme was added to raise the permittivity of water. However, it was confirmed that substantially the same result can be obtained without adding consomme.

In the experiment shown in FIGS. 5A to 5C, a glass container covered with a lid was used. However, the same result can be obtained using an uncovered container. Even in a case where a metal container covered with a lid through which microwaves cannot transmit is used, the value of the detected reflected microwave power changes largely because of the water vapor released through the gap between the container and the lid to heating chamber 1 during boiling and the water droplets adhered to the inner walls of heating chamber 1. From this change, it can be detected that heating target 2 is in the boiling state. In the experiment shown in FIGS. 5A to 5C, containers having the same weight are used.

Even if the weights of heating targets 2 are different from one another in the experiments shown in FIGS. 5A to 5C, a value of the standard deviation 1.5×10⁻³ may be used as a threshold value for determining the boiling state, so that the boiling state of heating target 2 can be detected using the same threshold value.

In the present exemplary embodiment, it is determined that heating target 2 is in the boiling state in a case where the value measured during the experiment (e.g., the standard deviation) exceeds the threshold value at least twice. With this determination, the boiling state of heating target 2 can be detected accurately, so that it is possible to prevent heating from being unwantedly stopped in a state before boiling.

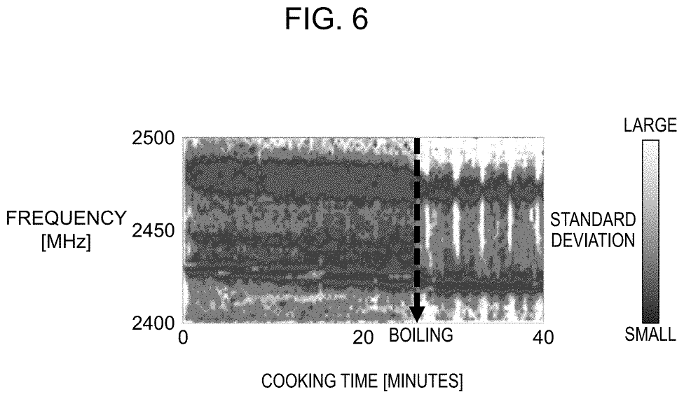

FIG. 6 shows temporal changes in the frequency average of the standard deviation in 10 seconds regarding the proportion of the reflected microwave power to the incident microwave power in a frequency band from 2400 MHz to 2500 MHz in a case where the weight of heating target 2 is 1200 g. In FIG. 6, the thinner color areas are larger in the standard deviation.

As shown in FIG. 6, frequency regions in which the standard deviation during boiling is large (the thin color regions in FIG. 6) appear at least at intervals of about 30 MHz. Therefore, the bandwidth of the frequency sweep may be set to 30 MHz or wider to improve the accuracy of detecting boiling of heating target 2.

The frequency range of the microwave used in the present experiment is the range from 2400 MHz to 2500 MHz, which is used in the generally used microwave ovens. Each dimension of the height, width, and depth of heating chamber 1 is set to approximately 300 mm, which is adequately large relative to the wavelength of the microwave.

Further, since each frequency band in which the frequency average of the standard deviation in 10 seconds regarding the proportion of the reflected microwave power to the incident microwave power is large is 10 MHz or wider, the frequency interval for the frequency sweep may be set to 10 MHz or narrower to improve the accuracy of detecting boiling of heating target 2.

There is a case that heating is finished at the time the boiling state of heating target 2 has been detected. On the other hand, there is also a case, like the case where heating target 2 is pot-au-feu, that heating target 2 must be kept in the boiling state for a certain length of time. In the latter case, the boiling state can be kept by an on/off control of the microwave output after detecting the boiling state.

In the manner as describe above, a variety of heating means including the microwave generator can be controlled by detecting the boiling state based on the temporal change in the frequency characteristic of the reflected microwave power returned from heating chamber 1. Accordingly, it is possible to appropriately cook a variety of heating targets 2.

### INDUSTRIAL APPLICABILITY

The microwave treatment device according to the present disclosure is applicable not only to consumer-use cookers which cook foods by induction heating, but also to industrial-use microwave heating devices including, for example, drying machines, pottery kilns, waste disposers, semiconductor manufacturing equipment, and chemical reactors.

### REFERENCE MARKS IN THE DRAWINGS

1 heating chamber

2 heating target

3 microwave generator

4 amplifier

5 feeder

6 detector

7 controller

8 storage

1. A microwave treatment device comprising:
a heating chamber configured to accommodate a heating target;
a microwave generator configured to generate a microwave;
a feeder configured to supply the microwave to the heating chamber;
a reflected-microwave-power detector configured to detect a reflected microwave power returned to the microwave generator;
a controller configured to control the microwave generator; and
a storage that stores a level of the reflected microwave power detected by the reflected-microwave-power detector together with a frequency of the microwave supplied to the heating chamber and an elapsed time after a start of heating the heating target,
wherein the controller is configured to cause the microwave generator to execute a frequency sweep over a specified frequency band, and the controller is configured to determine that the heating target is in a boiling state based on a temporal change in a value that is obtained based on the reflected microwave power at each frequency.

2. The microwave treatment device according to claim 1, further comprising an incident-microwave-power detector configured to detect an incident microwave power of the microwave generated by the microwave generator,
wherein a proportion of the reflected microwave power to the incident microwave power is used as the value that is obtained based on the reflected microwave power.

3. The microwave treatment device according to claim 1, wherein the controller is configured to determine that the heating target is in the boiling state based on either a change in a variance of the value that is obtained based on the reflected microwave power in a predetermined time or a change in a frequency average of the variance.

4. The microwave treatment device according to claim 1, wherein the controller is configured to determine that the heating target is in the boiling state based on either a change in a standard deviation of the value that is obtained based on the reflected microwave power in a predetermined time or a change in a frequency average of the standard deviation.

5. The microwave treatment device according to claim 3, wherein the predetermined time is equal to or longer than twice a period of the frequency sweep.

6. The microwave treatment device according to claim 1, wherein the controller is configured to determine that the heating target is in the boiling state in a case where the change exceeds a threshold value at two or more frequencies.

7. The microwave treatment device according to claim 1, wherein a bandwidth of the frequency sweep is equal to or wider than 30 MHz.

8. The microwave treatment device according to claim 1, wherein a frequency interval of the frequency sweep is equal to or narrower than 10 MHz.

9. The microwave treatment device according to claim 1, wherein the controller is configured to determine that the heating target is in the boiling state in a case where the change in the value that is obtained based on the reflected microwave power exceeds a threshold value at least twice.

10. The microwave treatment device according to claim 1, wherein the controller is configured to cause the microwave wave generator to execute the frequency sweep after the heating target in a liquid state has been placed in the heating chamber and a time necessary for fluctuations of a surface of the heating target to stop has elapsed after a start of heating the heating target.

11. The microwave treatment device according to claim 4, wherein the predetermined time is equal to or longer than twice a period of the frequency sweep.

12. The microwave treatment device according to claim 2, wherein the controller is configured to determine that the heating target is in the boiling state in a case where the change exceeds a threshold value at two or more frequencies.

13. The microwave treatment device according to claim 3, wherein the controller is configured to determine that the heating target is in the boiling state in a case where the change exceeds a threshold value at two or more frequencies.

14. The microwave treatment device according to claim 4, wherein the controller is configured to determine that the heating target is in the boiling state in a case where the change exceeds a threshold value at two or more frequencies.
